(19) United States
(12) Patent Application Publication
(10) Pub. No.: US 2008/0240084 A1
(43) Pub. Date: Oct. 2, 2008

(54) COMMUNICATION SYSTEM, SUBSCRIBER MANAGEMENT SERVER AND COMMUNICATION SYSTEM CONTROL METHOD

(76) Inventors: Shigeru Tsukiashi, Tokyo (JP); Keigo Murakami, Tokyo (JP)

Correspondence Address: NEC CORPORATION OF AMERICA, 6535 N. STATE HWY 161, IRVING, TX, 75039, US

(21) Appl. No.: 12/049,682

(22) Filed: Mar. 17, 2008

(30) Foreign Application Priority Data
Mar. 27, 2007 (JP) 81421/2007

(51) Int. Cl. H04L 12/66

(52) U.S. Cl. 370/352

(57) ABSTRACT

There is provided a communication system or the like including an IP phone network, a circuit switched network, and a shared terminal capable of connecting any one of the IP phone network and the circuit switched network, wherein, when the position of the shared terminal is registered or when a call is made from the shared terminal, the subscriber management server of the IP phone network and the subscriber management server of the circuit switched network give and receive the subscriber information about the shared terminal to share the subscriber information, and a call control server of the IP phone network and a call control server of the circuit switched network mediate the call from the shared terminal with the use of the subscriber information.

This application is based upon and claims the benefit of priority from Japanese Patent Application No. 2007-081421, filed on Mar. 27, 2007, the disclosure of which is incorporated herein in its entirety by reference.

### BACKGROUND OF THE INVENTION

1. Technical Field

The present invention relates to a communication system including an IP (Internet Protocol) phone network, a circuit switched network, and a shared terminal capable of connecting to any one of the IP phone network and the circuit switched network, a subscriber management server used in the communication system, and a method for controlling the communication system.

2. Background Art

The VoIP (Voice over IP) (also referred to as IP phone) service for performing voice communication on an IP network has conventionally gathered attention because more inexpensive system construction is possible in comparison with the conventional public switched telephone network (PSTN) using a circuit switched network, from the viewpoint of operation, accounting and the like.

Furthermore, there have been proposed and developed techniques and standards for integrating mobile communication systems, such as a mobile phone, and various communication networks, such as a public wireless LAN (Local Area Network) and a public switched telephone network, with a central focus on the VoIP technology to construct a next-generation network.

As an example of this kind of next-generation network architecture, for example, IMS (IP Multimedia Subsystem) by 3GPP (3rd Generation Partnership Project) is known (for example, 3GPP IP Multimedia Subsystem (IMS): http://www.3gpp.org/ftp/Specs/html-info/23228.htm). A network like the IMS can be considered to be of a network architecture for an IP phone network constructed on the IP network.

On such an IP phone network, when a call is made, a called terminal is identified by SIP (Session Initiation Protocol) between a calling terminal and a call control server to mediate connection between both terminals.

Though SIP techniques which are almost based on the specifications proposed by RFC3261 and the like have been already put to practical use in each of current IP phone services, there is also proposed a configuration using a SIP message having a further extended header for a communication system considered to be for a next-generation network, such as the IMS described above (for example, IMS call control protocol based on SIP and SDP: http://www.3gpp.org/ftp/Specs/html-info/24229.htm; and RFC3455 3GPP SIP extended header: http://www.ietf.org/rfc/rfc3455.txt).

In a communication system like the system by 3GPP, a subscriber management server like an HSS (Home Subscriber Server) is arranged on the IP network as a database for managing subscriber information so as to connect calls from various access networks constructed on the basis of various networks and enable roaming among the access networks.

In a SIP communication system like the system by 3GPP, a call control server, especially a SIP server for mediating connection of a call between calling and called terminals has been conventionally called a CSCF (Call Session Control Function).

Generally, when a SIP terminal enters a service area, a position registration sequence (generally, using a REGISTER message) is performed between the SIP terminal and a CSCF. In response to this, subscriber information and information about supplementary services are exchanged between the CSCF and an HSS. Since this sequence is related to user information such as a user ID and a telephone number, an authentication protocol such as the Diameter protocol (RFC3588 Diameter Base Protocol: http://www.ietf.org/rfc/rfc3588.txt) is used. In the case of the Diameter protocol, the sequence for exchanging subscriber information and information about supplementary services is performed by exchanging SAR/SAA messages (Diameter Cx interface).

On the other hand, under the existing circumstances, a mobile terminal communication network is widely used which is based on the circuit switched network (CS network) architecture in which the IP technology is basically not used for its fundamental parts, like the case of a mobile phone network. For the CS network also, a network architecture like IMT-2000 is also proposed by the International Telecommunication Union (ITU) as a so-called 3 G (the third-generation mobile phone). The IMT-2000 supports all of the wireless systems such as CDMA2000, W-CDMA, EDGE, TD-SCDMA and the like, and it is examined to use combination of the wireless systems. In the CS network, the subscriber management server is called an HLR (Home Location Register) and the like.

Even though any of the IMS network configured as an IP phone network and the CS network like IMT-2000 described above may be shaken out in the future, it is conceivable that there will be a period during which both of the IMS network and the CS network described above exist together during the stages of preparation of the next-generation communication network.

In such a transitional environment, it will be convenient if a subscriber can connect to any of the IP phone network and the CS network with one terminal. A shared terminal having such a function will be recognized as having a high added value.

Actually, however, there have not been prepared configurations yet for a communication system, a subscriber management server, a communication terminal, a communication method and the like for linking the IP phone network and the CS network so as to support a shared terminal capable of connecting to any of the IP phone network like IMS and the CS network such as IMT-2000.

At present, sufficient consideration is not given to, for example, how subscriber information of the subscriber management servers, that is, the HSS on the IP phone network and the HLR on the CS network is to be shared, how the subscriber information of the subscriber management servers can be used by the call control servers on the IP phone network and the CS network which accept position registration or connection of a shared terminal, how a call from such a shared terminal is transferred to another terminal, and the like.

### SUMMARY

An exemplary object of the invention is to provide a communication system, a subscriber management server and a communication system control method which can sufficiently support communication of a shared terminal capable of connecting an IP phone network and a circuit switched network.

An exemplary aspect of the invention includes a communication system including an IP phone network, a circuit switched network, and a shared terminal capable of connecting to any one of the IP phone network and the circuit switched network, a subscriber management server used in the communication system, and a method for controlling the communication system, wherein, when the position of the shared terminal is registered or when a call is made from the shared terminal, the subscriber management server of the IP phone network and the subscriber management server of the circuit switched network give and receive the subscriber information about the shared terminal to share the subscriber information, and a call control server of the IP phone network and a call control server of the circuit switched network mediate the call from the shared terminal with the use of the subscriber information.

In another exemplary aspect of the invention, a subscriber management server used for registration of subscriber information in the IP phone network and the circuit switched network and shared by the IP phone network and the circuit switched network is used; and, when the position of the shared terminal is registered, the subscriber information about the shared terminal is registered with the subscriber management server, and, when a call is made from the shared terminal, a call control server of the IP phone network and a call control server of the circuit switched network mediate the call from the shared terminal with the use of the subscriber information registered with the subscriber management server.

According to the above configuration, by a subscriber management server of an IP phone network and a subscriber management server of a circuit switched network giving and receiving subscriber information about a shared terminal to share the subscriber information, or by using a subscriber management server shared by the IP phone network and the circuit switched network and registering subscriber information about a shared terminal with the subscriber management server when the position of the shared terminal is registered, each of the call control servers of the IP phone network and the circuit switched network can use the subscriber information about the shared terminal connected to the other network to connect a call and provide a supplementary service beyond the IP phone network and the circuit switched network. That is, there is obtained an excellent advantage that it is possible to sufficiently support communication of a shared terminal capable of connecting to an IP phone network and a circuit switched network.

### BRIEF DESCRIPTION OF THE DRAWINGS

FIG. 1 is a diagram showing the configuration of a communication system of a first exemplary embodiment;

FIG. 2 is a diagram showing an example of a position registration sequence in the communication system in FIG. 1;

FIG. 3 is a diagram showing an example of the position registration sequence in the communication system in FIG. 1;

FIG. 4 is a diagram showing an example of a calling sequence in the communication system in FIG. 1;

FIG. 5 is a diagram showing an example of a call transfer sequence in the communication system in FIG. 1;

FIG. 6 is a diagram showing the configuration of a communication system of a second exemplary embodiment;

FIG. 7 is a diagram showing an example of a position registration sequence in the communication system in FIG. 6;

FIG. 8 is a diagram showing an example of the position registration sequence in the communication system in FIG. 6;

FIG. 9 is a diagram showing an example of a calling sequence in the communication system in FIG. 6; and

FIG. 10 is a diagram showing an example of a call transfer sequence in the communication system in FIG. 6.

### EXEMPLARY EMBODIMENTS

Two exemplary embodiments for a communication system using an IP phone network and a CS network as a communication environment, subscriber management servers sharing or linking subscriber information in this communication system, and a communication method in such a communication system will be shown below as exemplary embodiment examples for practicing the present invention with reference to drawings. Though, in each of the exemplary embodiments below, the IMS network architecture described above is assumed as the IP phone network, any equivalent IP phone network enables configuration equivalent to that of each exemplary embodiment to be realized.

### 1. First Exemplary Embodiment

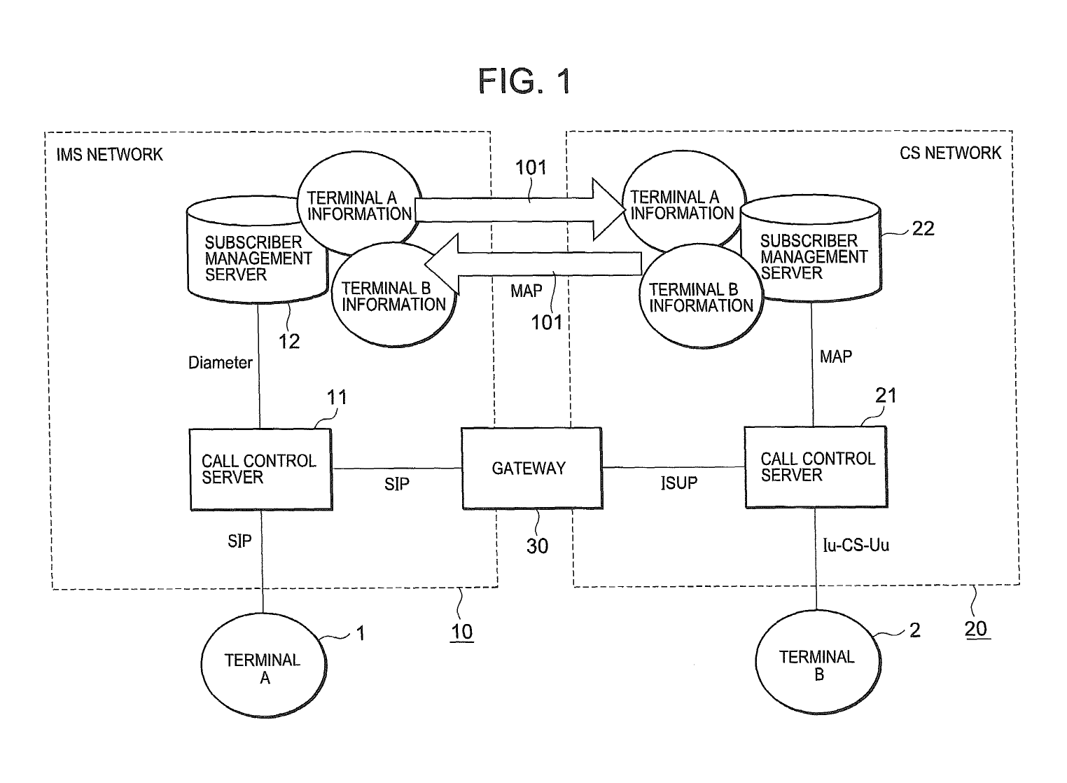

The configuration of the communication system of a first exemplary embodiment is shown in FIG. 1. In FIG. 1, reference numerals 1 and 2 denote terminals A and B, respectively, and reference numerals 10 and 20 denote an IMS network and a CS network, respectively.

These terminals 1 and 2 (A and B) have product specifications as a shared terminal configured so as to connect any one of an IMS network and a CS network according to a user's setting operation or according to the current position.

In this case, it does not matter whether the IMS network and the CS network are installed by the same carrier or the IMS and the CS network are installed by different carriers and the terminals 1 and 2 are connected to any of the networks by roaming. In any case, it is assumed that the terminals 1 and 2 are configured so that they cannot connect to the IMS network and the CS network at the same time but can connect to any one of the networks.

The IMS network 10 is constructed on an IP network and includes a call control server (CSCF) 11 and a subscriber management server (HSS) 12. The call control server 11 accepts position registration (REGISTER) or calling (INVITE) of the terminal 1 via the SIP protocol.

When the call control server 11 accepts position registration or calling from the terminal 1, it refers to subscriber data in the subscriber management server 12, and performs processings required for position registration or calling, for example, control of authentication and accounting. In this case, the Diameter Cx interface is used for information exchange between the call control server 11 and the subscriber management server 12.

The CS network 20 is assumed to be a communication network configured as a circuit switched network, for example, like IMT-2000 described above. On this CS network 20, a call control server 21 and a subscriber management server 22 are arranged. The call control server 21 accepts position registration or calling from the terminal 2 via a protocol such as Iu-CS/Uu.

When the call control server 21 accepts position registration or calling from the terminal 2, it refers to subscriber data in the subscriber management server 22, and performs processings required for position registration or calling, for example, control of authentication and accounting. In this case, an appropriate core network protocol such as MAP (Mobile Application Protocol) is used for communication between the call control server 21 and the subscriber management server 22.

Mutual connection between the IMS network 10 and the CS network 20 is performed with the use of a gateway 30. As the gateway 30, an apparatus like MGCF (Media Gateway Control Function) in IMS can be used.

As the interface protocol for the gateway 30, for example, SIP is used between the call control server 11 and the gateway 30 on the IMS network 10 side, and, for example, ISUP (The Integrated Services Digital Network User Part) is used between the call control server 21 and the gateway 30 on the CS network 20 side.

The network architecture, the protocols and the signal form shown in FIG. 1 are only an example. The IMS network 10 may be any IP phone network, and the CS network 20 may be any circuit switched network. These networks, and the protocols and the signal form used between the networks can be arbitrary selected by one skilled in the art, and the techniques of a first exemplary embodiment described later can be similarly applied.

In the above configuration, the subscriber management servers 12 and 22 are arranged on the IMS network 10 and the CS network 20, respectively, as described above. In FIG. 1, terminal information A and terminal information B correspond to the subscriber information about the terminals 1 and 2, respectively. As described above, the terminals 1 and 2 are configured so that they cannot connect to the IMS network and the CS network at the same time but can connect to only one of them.

In such a situation, the subscriber information in the subscriber management servers 12 and 22 cannot be shared conventionally. For example, it is not possible to use the subscriber information in the form of registering common subscriber information with both of the subscriber management servers 12 and 22 or in the form of the subscriber management servers 12 and 22 mutually requesting the subscriber information at a necessary timing.

Therefore, the terminals 1 and 2 can call each other only in a state that a connection form has been established that the call control server 11 on the IMS network 10 or the call control server 12 on the CS network 20 can use the subscriber information about both of the terminals 1 and 2, that is, in a state that both of the terminals 1 and 2 has connected (position registration) to the same one network between the IMS network 10 and the CS network 20.

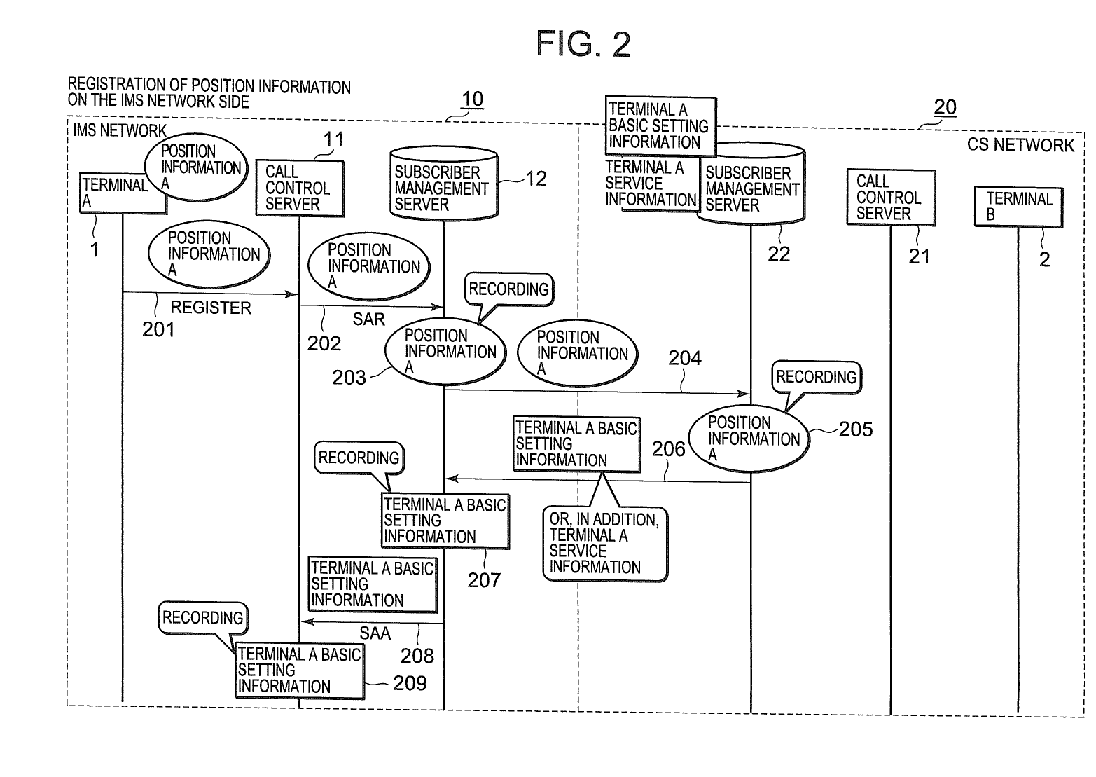

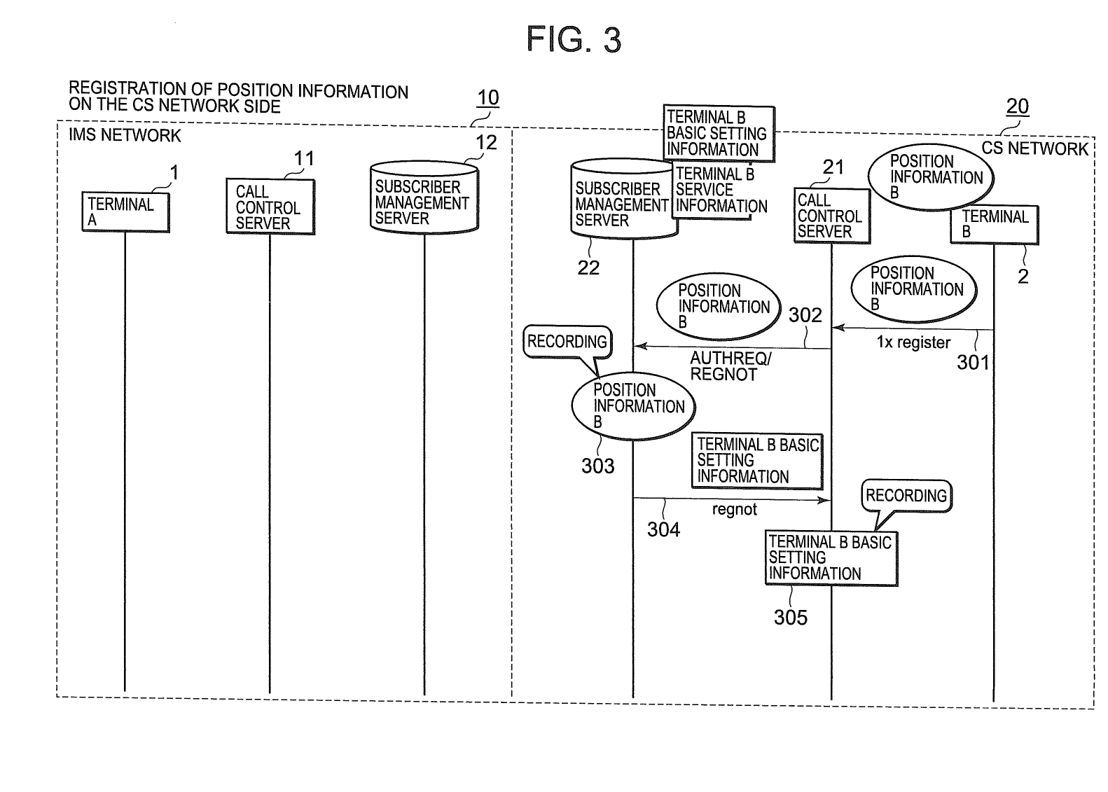

Therefore, the first exemplary embodiment is adapted to enable the subscriber management servers 12 and 22 mutually use subscriber information in the form of registering common subscriber information (the terminal information A in FIG. 1 in the example of FIG. 2) with both of the subscriber management servers 12 and 22 or in the form of the subscriber management servers 12 and 22 mutually requesting subscriber information (the terminal information B in FIG. 1 in the example of FIG. 3) at a necessary timing.

In order to realize this, a configuration is made so that the subscriber management servers 12 and 22 can communicate with the use of the MAP protocol at the time of performing position registration or at a necessary timing in the first exemplary embodiment, as shown by reference numeral 101 in FIG. 1. Therefore, each of the subscriber management servers 12 and 22 is provided with a communication interface for performing communication with the MAP protocol, as communication means between the subscriber management servers.

FIGS. 2 and 3 show examples of a position registration sequence in the first exemplary embodiment. FIG. 2 shows an example of a sequence performed in the case where the terminal 1 (A) enters a particular service area of the IMS network 10 and performs position registration, and FIG. 3 shows an example of a sequence performed in the case where the terminal 2 (B) enters a particular service area of the CS network 20 and performs position registration.

In FIG. 2, when the terminal 1 (A) enters the particular service area of the IMS network 10, the terminal 1 registers its position with the call control server 11 with the use of a SIP message REGISTER (201). The call control server 11 exchanges SAR messages with the subscriber management server 12 via the Diameter Cx interface (202).

In this way, the position information A about the terminal 1 is communicated to the call control server 11 (201 and 202) and recorded in the subscriber management server 12 (203).

Furthermore, in the first exemplary embodiment, the subscriber management servers 12 and 22 perform communication by the MAP protocol, the position information A about the terminal 1 is transmitted to the subscriber management server 22 (204) and recorded (205). The subscriber management server 22 registers terminal A service information about terminal A basic setting information, supplementary service and the like, on the basis of the position information A about the terminal 1.

Then, the subscriber management server 22 transmits the terminal A basic setting information (or, in addition thereto, the terminal A service information) to the subscriber management server 12 by the MAP protocol (206), and the subscriber management server 12 registers the terminal A basic setting information (or, in addition thereto, the terminal A service information) (207).

Furthermore, by transmitting an SAA message via the Diameter Cx interface, the subscriber management server 12 transmits the terminal A basic setting information (or, in addition thereto, the terminal A service information) to the call control server 11 (208), and this terminal A basic setting information (or, in addition thereto, the terminal A service information) is recorded in the call control server 11 (209).

As described above, the common position information A about the terminal 1 is registered with the subscriber management servers 12 and 22 of both of the IMS network 10 and CS network 20, and the common setting information about the terminal 1, that is, the terminal A basic setting information is registered with both of the call control servers 11 and 21.

In FIG. 3, when the terminal 2 (B) enters a particular service area of the CS network 20, the terminal 2 registers the position information B about itself with the call control server 21 with the use of the Iu-CS/Uu protocol (1x register 301). This position information B is transmitted to the subscriber management server 22 (AUTHREQ/REGNOT 302) via the MAP protocol and registered on the subscriber management server 22 (303).

The subscriber management server 22 registers terminal B basic setting information, and terminal B service information about supplementary services, on the basis of the position information B about the terminal 2. The terminal B basic setting information is transmitted to the call control server 21 via the MAP protocol (regnot 304) and registered with the subscriber control server 21 (305).

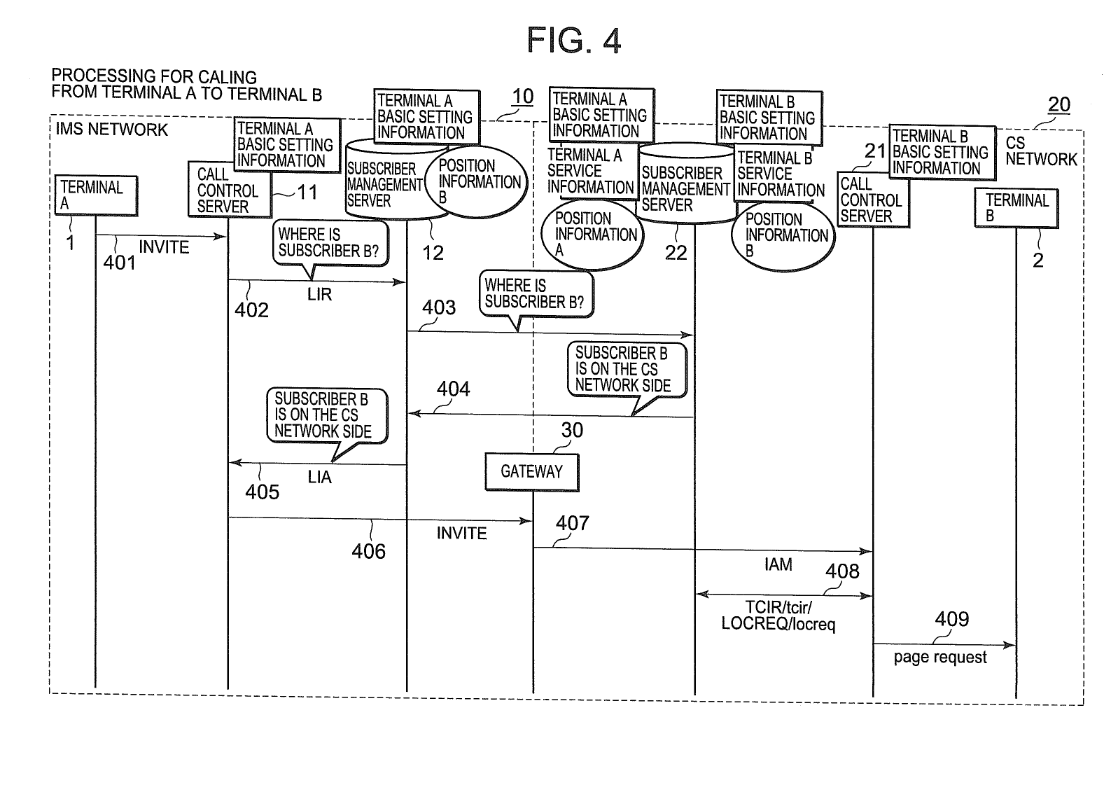

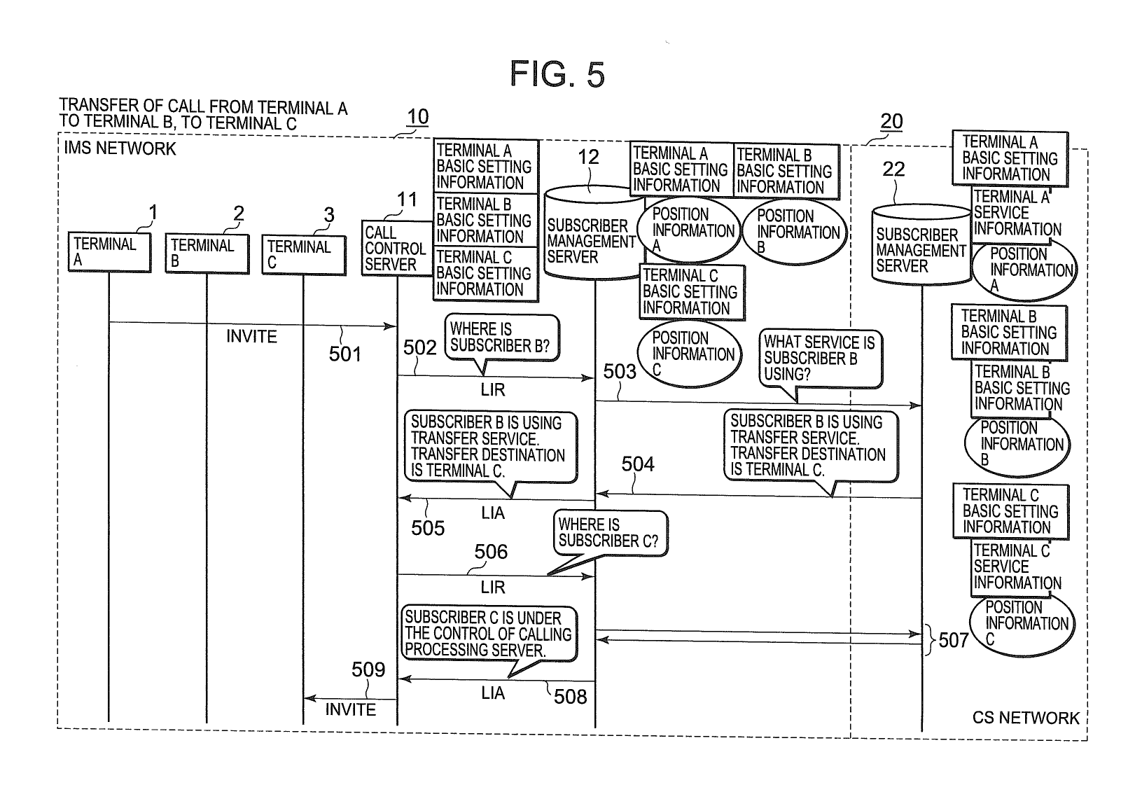

When the position registration sequences in FIGS. 2 and 3 have been completed, it becomes possible to make a call from the terminal 1 (A) to the terminal 2 (B) and further transfer it to a terminal 3 (C), as shown in FIGS. 4 and 5, respectively.

FIG. 4 shows an example of a sequence of calling from the terminal 1 (A) which has been position-registered as described above to the terminal 2 (B) which has been position-registered similarly.

In FIG. 4, when the terminal 1 (A) dials to call the terminal 2 (B), a SIP message INVITE is transmitted to the call control server 11 (401).

The call control server 11 transmits an LIR message to the subscriber management server 12 via the Diameter Cx interface to inquire about the current position of the subscriber B of the terminal 2 (402).

In the position registration state in FIG. 4, since the position information/setting information about the terminal 2 (B) has not been registered with the subscriber management server 12 yet. Therefore, when detecting a call to an unregistered subscriber, the subscriber management server 12 inquires of the subscriber management server 22 about the current position of the subscriber B with the use of the MAP protocol (403). In response to this, the subscriber management server 22 notifies the subscriber management server 12 of the current position of the subscriber B with the use of the position information B about the subscriber B with the use of the MAP protocol (404).

The subscriber management server 12 transmits an LIA message via the Diameter Cx interface to notify that the subscriber B stays on the CS network 20 side (405).

In this way, the call control server 11 can recognize that the terminal B has already registered its position on the CS network 20 side, and therefore, it transmits a SIP message INVITE to the gateway 30 (406).

In response to this, the gateway 30 communicates with the call control server 21 on the CS network 20 side (IAM 407, TCIR/tcir/LOCREQ/locreq 408) with the use of the ISUP interface, and the call from the terminal 1 (A) to the terminal 2 (B) is connected by the call control server 21 transmitting a page request to the terminal 2 (B) (409).

By the subscriber management servers 12 and 22 exchanging the subscriber information (position information/setting information) at a necessary timing as in FIG. 4, calling from the terminal 1 which has registered its position with the IMS network 10 to the terminal 2 which has registered its position with the CS network 20 is enabled.

The subscriber information exchanged by the subscriber management servers 12 and 22 is not limited to the position information/setting information described above, and it is also possible to exchange the supplementary service information as the subscriber information as in FIG. 5. Thereby, transfer of the call to a third terminal is enabled.

FIG. 5 shows an example of a sequence performed in the case of transferring a call from the terminal 1 (A) to the terminal 2 (B), to the terminal 3 (C). In the example of FIG. 5, it is assumed that all of the terminals 1 (A), 2 (B) and 3 (C) have already registered their positions on the IMS network 10. In this case, the terminal 3 (C) is assumed to be a terminal capable of connecting to at least the IMS network 10 or a terminal equivalent to the terminal 1 (A) or the terminal 2 (B).

The position registration of each terminal is performed by a sequence equivalent to that in FIG. 2. As a result, the basic setting information about the terminals A, B and C is registered with the call control server 11 of the IMS network 10 as shown in FIG. 5. Furthermore, the position information, the basic setting information and service information for controlling supplementary communication services about the terminals A, B and C are registered with the subscriber management server 22 of the CS network 20.

A transfer service for transferring a call to the terminal 2 (B) to the terminal 3 (C) is set for the terminal 2 (B), and information specifying transfer control corresponding to the transfer setting is registered with the subscriber management server 22 as the service information about the terminal B.

In such a state, when a call is made and received, the subscriber management servers 12 and 22 can transfer the call from the terminal A to the terminal B further to the terminal C by mutually requesting the subscriber information at a necessary timing.

In FIG. 5, when the terminal 1 (A) calls the terminal 2 (B), a SIP message is transmitted to the call control server 11 similarly as described before (501).

In response to this, the call control server 11 transmits an LIR message to the subscriber management server 12 via the Diameter Cx interface, and inquires about the current position of the subscriber B of the terminal 2 (B) (502).

In the position registration state in FIG. 5, the position information/setting information about the terminal 2 (B) is registered with the subscriber management server 12. In the example of FIG. 5, it is assumed that the service information about the terminal 2 (B) has not been transferred to the subscriber management server 12 unlike the case of FIG. 2. In this case, the subscriber management server 12 on the IMS side inquires of the subscriber management server 22 on the CS side about the current state of use of services by the subscriber B, by the MAP protocol (503).

The subscriber management server 22 on the CS side makes a response to the effect that the subscriber B is using the transfer service and that the destination of the transfer is the terminal 3 (C), by the MAP protocol (504). Furthermore, by transmitting an LIA message from the subscriber management server 12 via the Diameter Cx interface, information to the effect that the subscriber B is using the transfer service and that the transfer destination is the terminal 3 (C) is notified to the call control server 11 (505).

In response to this, the call control server 11 transmits an LIR message to the subscriber management server 12 via the Diameter Cx interface to inquire about the current position of the subscriber C of the terminal 3 (C) (506).

The position information/setting information about the terminal C(3) is already registered with the subscriber management server 12. Therefore, by the subscriber management server 12 transmitting an LIA message via the Diameter Cx interface, information to the effect that the terminal C (3) is positioned under the control of the call control server 11 is notified to the call control server 11 (508). The subscriber management server 12 also inquires of the subscriber management server 22 about the current state of use of services by the subscriber C, by the MAP protocol (507). This sequence is necessary because there is a possibility that a service such as the transfer service may be further set for the terminal of the subscriber C.

As described above, the call control server 11 can identify the transmission destination of an INVITE message (509), and a call from the terminal 1 (A) to the terminal 2 (B) can be transferred to the terminal 3 (C).

As described above, according to the first exemplary embodiment, the subscriber management servers 12 and 22 on the IMS network 10 and the CS network 20 can mutually use the subscriber information in the form of the subscriber management servers 12 and 22 sharing the subscriber information, especially in the form of registering the subscriber information (the terminal information A in FIG. 1 in the example of FIG. 2) or in the form of the subscriber management servers 12 and 22 mutually requesting the subscriber information (the terminal information B in FIG. 1 in the example of FIG. 3) at a necessary timing.

Thus, according to the first exemplary embodiment, it is possible for the terminals 1, 2, 3, . . . capable of connecting to any of the IMS network 10 and the CS network 20 to mutually make a call between the IMS network 10 and the CS network 20 or, in addition, provide supplementary services such as a transfer service by referring to shared subscriber information, no matter which network the terminals are connected to.

That is, according to the first exemplary embodiment, the call control server on the IMS network and the call control server on the CS network can use subscriber information about a shared terminal connected to the other network to connect a call and provide a supplementary service beyond the IMS network and the CS network, respectively. That is, there is obtained an excellent advantage that it is possible to sufficiently support communication of a shared terminal capable of connecting to the IMS network and the CS network.

### 2. Second Exemplary Embodiment

In the first exemplary embodiment, a network architecture has been shown in which the subscriber management servers 12 and 22 are provided on the IMS network 10 and the CS network 20, respectively, as an example. However, a configuration is also conceivable in which the same subscriber management server is shared by the IMS network 10 and the CS network 20 like a second exemplary embodiment.

The configuration and the operation of the communication system of the second exemplary embodiment will be described below. The members similar to or corresponding to the members in FIG. 1 to FIG. 5 of the first exemplary embodiment are given the same reference numerals, and detailed description thereof will be omitted unless it is necessary.

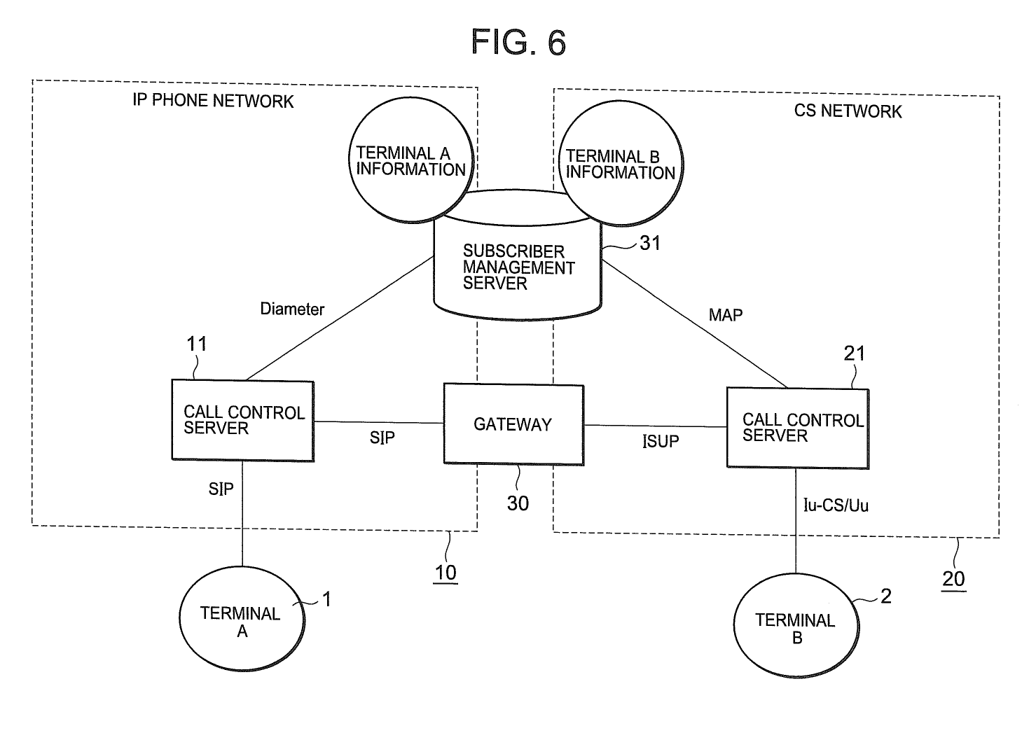

FIG. 6 shows the configuration of the communication system of the second exemplary embodiment. As apparently seen from comparison with FIG. 1, the configuration in FIG. 6 is different from the first exemplary embodiment in that only one subscriber management server 31 shared by the IMS network 10 and the CS network 20 is provided between the IMS network 10 and the CS network 20.

In the second exemplary embodiment, both of the terminal information A and B about the terminal 1 (A) and the terminal 2 (B) are registered with this common subscriber management server 31.

Then, the call control servers 11 and 21 of the IMS network 10 and the CS network 20 perform communication control for calling, transfer and the like by referring to the registered information in the subscriber management server 31. In this case, the call control server 11 uses the Diameter Cx interface for communication with the subscriber management server 31, and the call control server 21 uses the MAP protocol for communication with the subscriber management server 31.

Therefore, it is sufficient if the subscriber management server 31 is provided with the Diameter communication interface on the IMS network 10 side, and a communication interface for performing communication by the MAP protocol on the CS network 20 side.

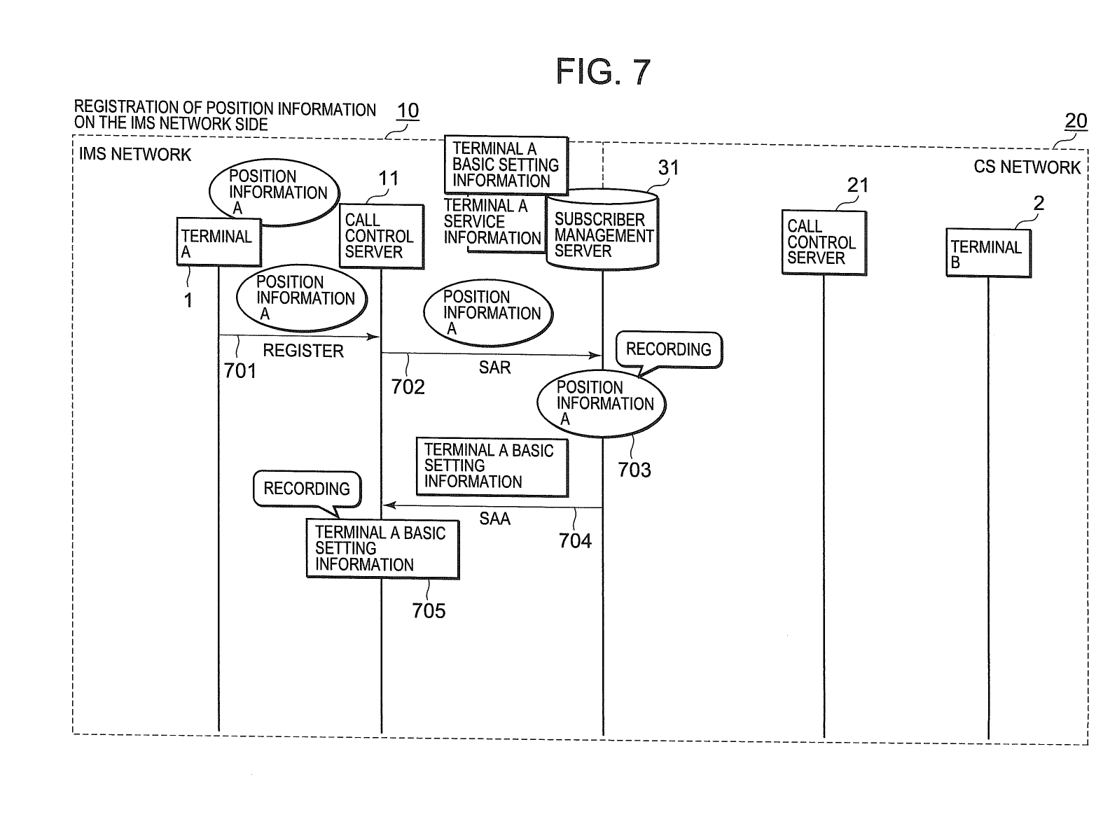

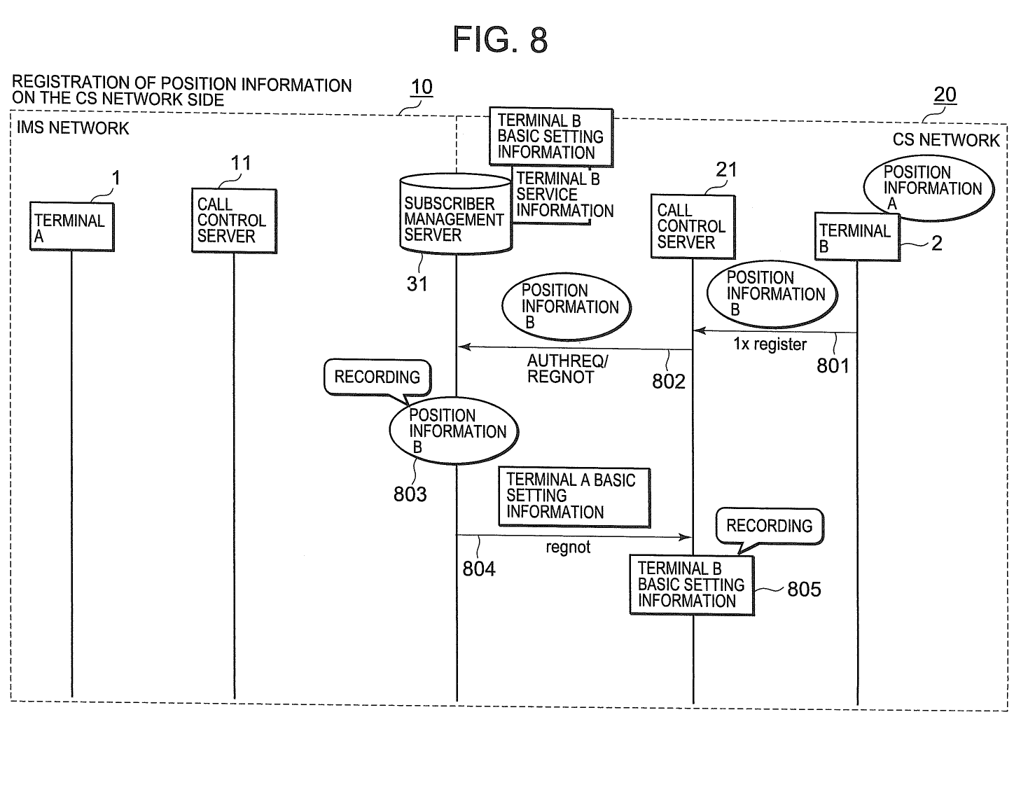

FIGS. 7 and 8 show examples of a position registration sequence in the second exemplary embodiment. FIG. 7 shows an example of a sequence performed in the case where the terminal 1 (A) enters a particular service area of the IMS network 10 and performs position registration, and FIG. 8 shows an example of a sequence performed in the case where the terminal 2 (B) enters a particular service area of the CS network 20 and performs position registration.

In FIG. 7, when the terminal 1 (A) enters the particular service area of the IMS network 10, the terminal 1 registers its position with the call control server 11 with the use of a SIP message REGISTER (701). The call control server 11 exchanges SAR messages with the subscriber management server 31 via the Diameter Cx interface (702).

In this way, the position information A about the terminal 1 is communicated to the call control server 11 (701 and 702) and recorded in the subscriber management server 31 (703).

Furthermore, by transmitting an SAA message via the Diameter Cx interface, the subscriber management server 31 transmits the terminal A basic setting information (or, in addition thereto, the terminal A service information) to the call control server 11 (704), and this terminal A basic setting information (or, in addition thereto, the terminal A service information) is recorded in the call control server 11 (705).

As described above, the position information A about the terminal 1 is registered with the subscriber management servers 31 shared by both of the IMS network 10 and the CS network 20, and setting information about the terminal 1, that is, the terminal A basic setting information is registered with the call control server 1.

In FIG. 3, when the terminal 2 (B) enters a particular service area of the CS network 20, the terminal 2 registers the position information B about itself with the call control server 21 with the use of the Iu-CS/Uu protocol (1x register 801). This position information B is transmitted to the subscriber management server 31 (AUTHREQ/REGNOT 802) via the MAP protocol and registered on the subscriber management server 31 (803).

The subscriber management server 31 registers terminal B basic setting information or, in addition, terminal B service information about supplementary services, on the basis of the position information B about the terminal 2. The terminal B basic setting information is transmitted to the call control server 21 via the MAP protocol (regnot 804) and registered on the call control server 21 (805).

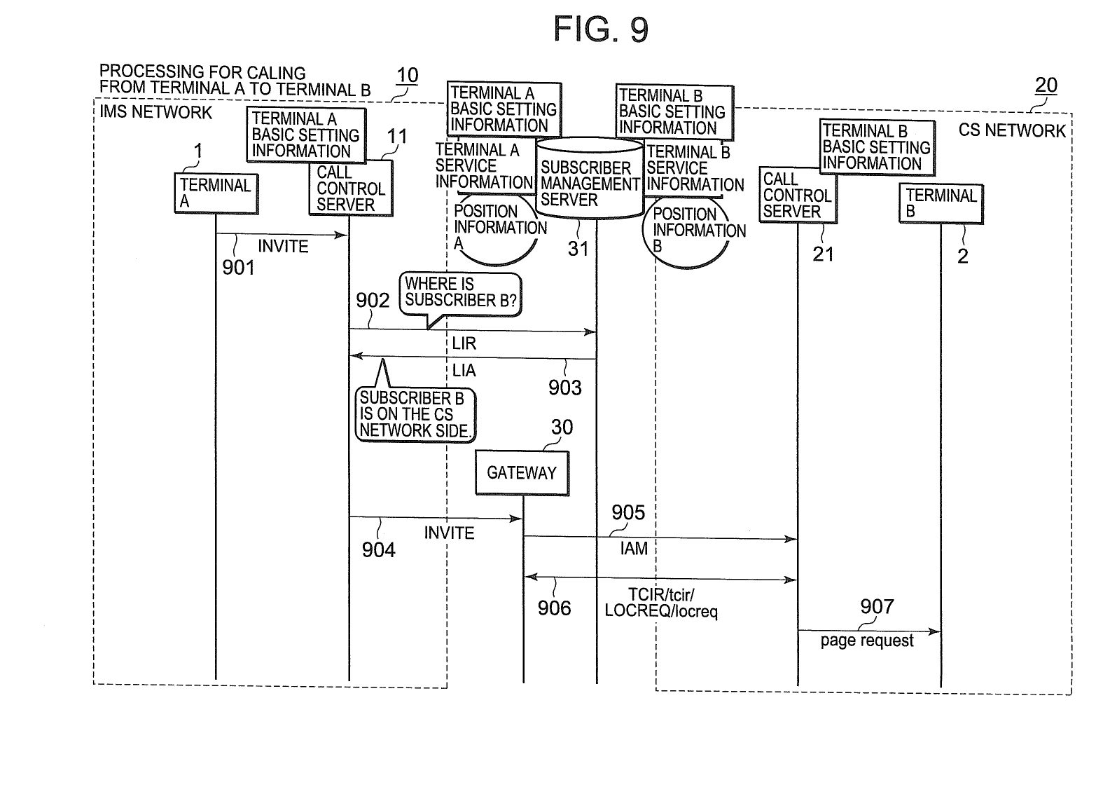

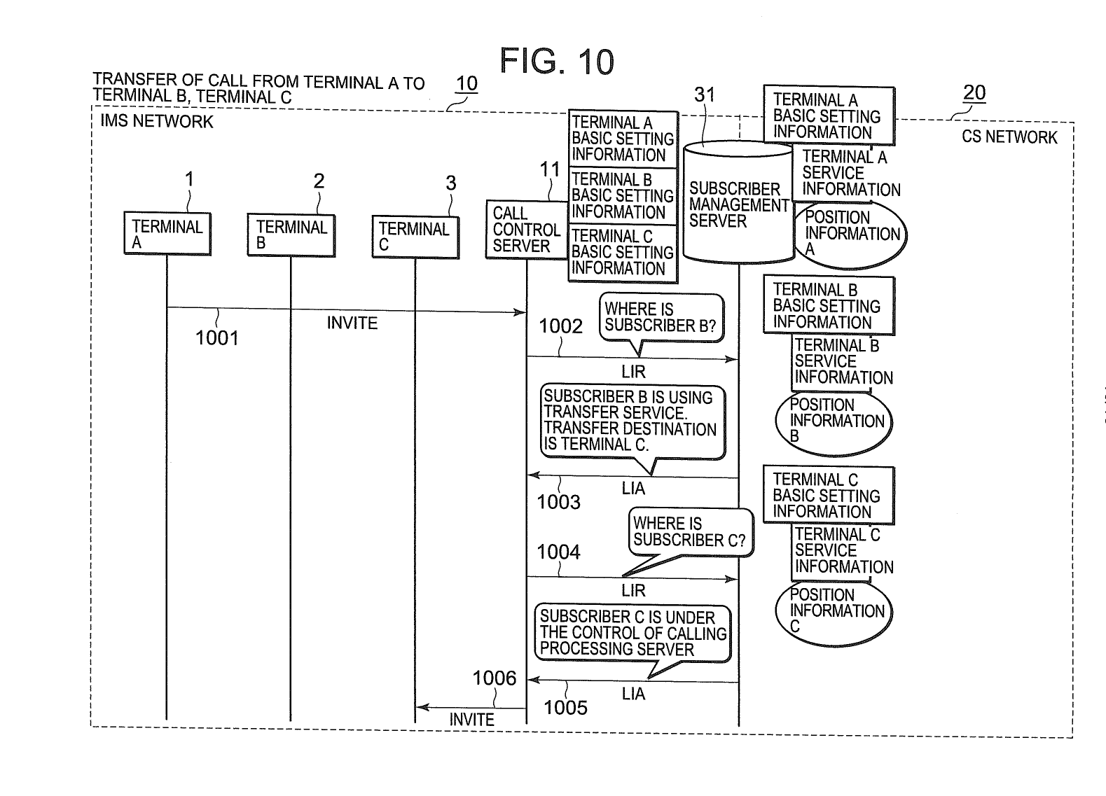

When the position registration sequences in FIGS. 7 and 8 have been completed, it becomes possible to make a call from the terminal 1 (A) to the terminal 2 (B) and further transfer it to a terminal 3 (C), as shown in FIGS. 9 and 10, respectively.

FIG. 7 shows an example of a sequence of calling from the terminal 1 (A) which has been position-registered as described above to the terminal 2 (B) which has been position-registered similarly.

In FIG. 7, when the terminal 1 (A) dials to call the terminal 2 (B), a SIP message INVITE is transmitted to the call control server 11 (901).

The call control server 11 transmits an LIR message to the subscriber management server 31 via the Diameter Cx interface to inquire about the current position of the subscriber B of the terminal 2 (B) (902).

In the position registration state in FIG. 9, since both of the position information/setting information about the terminal 1 (A) and the terminal 2 (B) are registered with the subscriber management server 31, the subscriber management server 31 immediately transmits an LIA message via the Diameter Cx interface to notify that the subscriber B stays on the CS network 20 side (903).

Thereby, the call control server 11 recognizes that the terminal B has already registered its position on the CS network 20 side, and it transmits a SIP message INVITE to the gateway 30 (904).

In response to this, the gateway 30 communicates with the call control server 21 on the CS network 20 side (IAM 905, TCIR/tcir/LOCREQ/locreq 906) with the use of the ISUP interface, and the call from the terminal 1 (A) to the terminal 2 (B) is connected by the call control server 21 transmitting a page request to the terminal 2 (B) (907).

By registering the positions of the terminals on both of the IMS network 10 and the CS network 20 with the subscriber management server 31 shared by the IMS network 10 and the CS network 20 and managing subscriber information (position information/setting information) as in FIG. 9, it becomes possible to make a call from the terminal 1 which is position-registered on the IMS network 10 to the terminal 2 which is position-registered on the CS network 20. Similarly, it becomes possible to make a call from the terminal 2 which is position-registered on the CS network 20 to the terminal 1 which is position-registered on the IMS network 10.

FIG. 10 shows an example of a sequence performed in the case of transferring a call from the terminal 1 (A) to the terminal 2 (B), to the terminal 3 (C). In the example of FIG. 10, it is assumed that all of the terminals 1 (A), 2 (B) and 3 (C) have already registered their positions on the IMS network 10. In this case, the terminal 3 (C) is assumed to be a terminal capable of connecting to at least the IMS network 10 or a terminal equivalent to the terminal 1 (A) or the terminal 2 (B).

The position registration of each terminal is performed by a sequence equivalent to that in FIG. 7. As a result, the basic setting information about the terminals A, B and C is registered with the call control server 11 of the IMS network 10 as shown in FIG. 10. The position information, the basic setting information and the service information about the terminals A, B and C are registered with the subscriber management server 31 shared by the IMS network 10 and the CS network 20.

Transfer setting for transferring a call to the terminal 2 (B) to the terminal 3 (C) is made for the terminal 2 (B), and information specifying transfer control corresponding to the transfer setting is registered with the subscriber management server 31 as the service information about the terminal B.

In such a state, the call control server 11 can transfer a call from the terminal A to the terminal B further to the terminal C by using the subscriber information in the subscriber management server 31.

In FIG. 10, when the terminal 1 (A) calls the terminal 2 (B), a SIP message is transmitted to the call control server 11 similarly as described before (1001).

In response to this, the call control server 11 transmits an LIR message to the subscriber management server 31 via the Diameter Cx interface, and inquires about the current position of the subscriber B of the terminal 2 (B) (1002).

In the position registration state in FIG. 10, since the position information, the setting information and the service information about the terminal 2 (B) have already been registered with the subscriber management server 31, information to the effect that the subscriber B is using the transfer service and the transfer destination is the terminal 3 (C) is notified to the call control server 11 by the subscriber management server 31 transmitting an LIA message via the Diameter Cx interface (1003).

In response to this, the call control server 11 transmits an LIR message to the subscriber management server 31 via the Diameter Cx interface, and inquires about the current position of the subscriber C of the terminal 3 (C) (1004).

The position information/setting information about the terminal C (3) is already registered with the subscriber management server 31. Therefore, by the subscriber management server 31 transmitting an LIA message via the Diameter Cx interface, information to the effect that the terminal C (3) is positioned under the control of the call control server 11 is notified to the call control server 11 (1005).

As described above, the call control server 11 can identify the transmission destination of an INVITE message (1006), and a call from the terminal 1 (A) to the terminal 2 (B) can be transferred to the terminal 3 (C).

As described above, the second exemplary embodiment adopts a configuration in which only one subscriber management server 31 shared by the IMS network 10 and the CS network 20 is provided between the IMS network 10 and the CS network 20, and the terminal information (subscriber information) about all of the terminal 1 (A), the terminal 2 (B) and the terminal 3 (C) is registered with this common subscriber management server 31.

Accordingly, both of the call control server 11 and the call control server 21 of the IMS network 10 and the CS network 20 can use the subscriber information about any of the terminal 1 (A), the terminal 2 (B) and the terminal 3 (C) only by accessing the subscriber management server 31.

Thus, according to the second exemplary embodiment, it is possible for the terminals 1, 2, 3, . . . capable of connecting to any of the IMS network 10 and the CS network 20 to mutually make a call between the IMS network 10 and the CS network 20 or, in addition, provide supplementary services such as a transfer service by referring to shared subscriber information, no matter which network the terminals connect to.

That is, in the second exemplary embodiment also, the call control server on the IMS network and the call control server on the CS network can use subscriber information about a shared terminal connected to the other network to connect a call and provide a supplementary service beyond the IMS network and the CS network, respectively. That is, there is obtained an excellent advantage that it is possible to sufficiently support communication of a shared terminal capable of connecting to the IMS network and the CS network.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A communication system comprising an IP phone network, a circuit switched network, and a shared terminal capable of connecting any one of the IP phone network and the circuit switched network, the communication system comprising:
a communication part to give and to receive subscriber information about the shared terminal between a subscriber management server of the IP phone network and a subscriber management server of the circuit switched network; wherein
when the position of the shared terminal is registered or when a call is made from the shared terminal, the subscriber management server of the IP phone network and the subscriber management server of the circuit switched network give and receive the subscriber information about the shared terminal via the communication part to share the subscriber information, and a call control server of the IP phone network and a call control server of the circuit switched network mediate the call from the shared terminal with the use of the subscriber information.

2. The communication system according to claim 1, wherein service information about a supplementary communication service to be provided for the shared terminal is registered with the subscriber management server together with the subscriber information, and the communication service is provided for the shared terminal with the use of the service information.

3. The communication system according to claim 2, wherein the communication service is a transfer service for transferring a call between the shared terminals to another terminal.

4. A communication system comprising an IP phone network, a circuit switched network, and a shared terminal capable of connecting any one of the IP phone network and the circuit switched network, the communication system comprising:
a subscriber management server used for registration of subscriber information in the IP phone network and the circuit switched network and shared by the IP phone network and the circuit switched network; wherein
when the position of the shared terminal is registered, the subscriber information about the shared terminal is registered with the subscriber management server, and, when a call is made from the shared terminal, a call control server of the IP phone network and a call control server of the circuit switched network mediate the call from the shared terminal with the use of the subscriber information registered with the subscriber management server.

5. The communication system according to claim 4, wherein service information about a supplementary communication service to be provided for the shared terminal is registered with the subscriber management server together with the subscriber information, and the communication service is provided for the shared terminal with the use of the service information.

6. The communication system according to claim 5, wherein the communication service is a transfer service for transferring a call between the shared terminals to another terminal.

7. A subscriber management server installed on an IP phone network or a circuit switched network in a communication system comprising the IP phone network, the circuit switched network, and a shared terminal capable of connecting any one of the IP phone network and the circuit switched network, the subscriber management server comprising:
a communication part to give and to receive subscriber information about the shared terminal to and from a subscriber management server installed on the circuit switched network or the IP phone network that is not the network on which the subscriber management server itself is installed; wherein
when the position of the shared terminal is registered or when a call is made from the shared terminal, the subscriber management server gives and receives the subscriber information about the shared terminal to and from a subscriber management server installed on the circuit switched network or the IP phone network that is not the network on which the subscriber management server itself is installed, via the communication part, to share the subscriber information.

8. The subscriber management server according to claim 7, wherein service information about supplementary communication service to be provided for the shared terminal is registered together with the subscriber information.

9. The subscriber management server according to claim 8, wherein the communication service is a transfer service for transferring a call between the shared terminals to another terminal.

10. A subscriber management server installed on an IP phone network or a circuit switched network in a communication system comprising the IP phone network, the circuit switched network, and a shared terminal capable of connecting any one of the IP phone network and the circuit switched network, the subscriber management server comprising:
a communication part to give and to receive subscriber information to and from call control servers of the IP phone network and the circuit switched network, the communication part being intended to be shared for registration of the subscriber information in the IP phone network and the circuit switched network; wherein
when the position of the shared terminal is registered, the subscriber management server registers the subscriber information about the shared terminal given to and received from the call control servers via the communication part.

11. The subscriber management server according to claim 10, wherein service information about supplementary communication service to be provided for the shared terminal is registered together with the subscriber information.

12. The subscriber management server according to claim 11, wherein the communication service is a transfer service for transferring a call between the shared terminals to another terminal.

13. A control method for a communication system comprising an IP phone network, a circuit switched network, and a shared terminal capable of connecting any one of the IP phone network and the circuit switched network, wherein
when the position of the shared terminal is registered or when a call is made from the shared terminal, the subscriber management server of the IP phone network and the subscriber management server of the circuit switched network give and receive the subscriber information about the shared terminal to share the subscriber information, and a call control server of the IP phone network and a call control server of the circuit switched network mediate the call from the shared terminal with the use of the subscriber information.

14. The communication system control method according to claim 13, wherein service information about a supplementary communication service to be provided for the shared terminal is registered with the subscriber management server together with the subscriber information, and the communication service is provided for the shared terminal with the use of the service information.

15. The communication system control method according to claim 14, wherein the communication service is a transfer service for transferring a call between the shared terminals to another terminal.

16. A control method for a communication system comprising an IP phone network, a circuit switched network, and a shared terminal capable of connecting any one of the IP phone network and the circuit switched network, wherein
a subscriber management server used for registration of subscriber information in the IP phone network and the circuit switched network and shared by the IP phone network and the circuit switched network is used; and
when the position of the shared terminal is registered, the subscriber information about the shared terminal is registered with the subscriber management server, and, when a call is made from the shared terminal, a call control server of the IP phone network and a call control server of the circuit switched network mediate the call from the shared terminal with the use of the subscriber information registered with the subscriber management server.

17. The communication system control method according to claim 16, wherein service information about a supplementary communication service to be provided for the shared terminal is registered with the subscriber management server together with the subscriber information, and the communication service is provided for the shared terminal with the use of the service information.

18. The communication system control method according to claim 17, wherein the communication service is a transfer service for transferring a call between the shared terminals to another terminal.
